(19) United States
(12) Patent Application Publication
(10) Pub. No.: US 2025/0133303 A1
(43) Pub. Date: Apr. 24, 2025

(54) OPTICAL ELEMENT AND OPTICAL DEVICE

(71) Applicant: SONY GROUP CORPORATION, TOKYO (JP)

(72) Inventor: HIROYUKI SHIGEI, TOKYO (JP)

(21) Appl. No.: 18/834,781

(22) PCT Filed: Jan. 26, 2023
(86) PCT No.: PCT/JP2023/002382

§ 371 Date: Jul. 31, 2024

(30) Foreign Application Priority Data
Feb. 9, 2022 (JP) 2022-018455

(51) Int. Cl. H04N 23/955; G03B 19/16; H04N 23/55

(52) U.S. Cl. CPC H04N 23/955; G03B 19/16; H04N 23/55

(57) ABSTRACT

The present technology relates to an optical element and an optical device that enable resolution of a light image to be increased at a position according to the position of the light image to be detected in an optical element that forms an image without a lens.

The optical element includes an optical element plate that includes, in part, a light transmission part forming a light image of an object by light from the object, the light having passed through a transparent zone that transmits light, and that blocks light in a portion other than the transparent zone, in which the transparent zone is formed such that resolution of a light image formed in a direction different from a normal direction of a plate surface of the optical element plate with respect to the light transmission part is higher than resolution of a light image formed in the normal direction.

### TECHNICAL FIELD

The present technology relates to an optical element and an optical device, and more particularly to an optical element and an optical device that can increase resolution of a light image at a position on an image surface of the optical element according to the position of the light image to be detected, the optical element being one that forms an image without a lens but by using a pinhole, a zone plate, a photon sieve, and the like.

### BACKGROUND ART

Patent Document 1 proposes a thin lens using a grating zone (sawtooth-shaped region) that forms good condensing characteristics without aberration with respect to oblique incidence.

### CITATION LIST

### Patent Document

Patent Document 1: Japanese Patent Application Laid-Open No. 4-084103

### SUMMARY OF THE INVENTION

### Problems to be Solved by the Invention

An optical element (image forming optical element) that forms an image without a lens but by a pinhole, a zone plate, a photon sieve, and the like is constituted of a thin plate (optical element plate) having a transparent zone through which light passes and an opaque zone in which light is blocked. In this type of optical element, the resolution of the light image formed by light from the normal direction of the optical element plate is the highest. However, in a case where a light image formed by the light from an oblique direction different from the normal direction of the optical element plate is set as a light image to be detected, the light image is desired to have high resolution.

The present technology has been made in view of such a situation, and enables the resolution of a light image to be increased at a position according to the position of the light image to be detected in an optical element that forms an image without a lens.

### Solutions to Problems

An optical element according to a first aspect of the present technology is an optical element including an optical element plate that includes, in part, a light transmission part forming a light image of an object by light from the object, the light having passed through a transparent zone that transmits light, and that blocks light in a portion other than the transparent zone, in which the transparent zone is formed such that resolution of a light image formed in a direction different from a normal direction of a plate surface of the optical element plate with respect to the light transmission part is higher than resolution of a light image formed in the normal direction.

The optical element according to the first aspect of the present technology includes an optical element plate that includes, in part, a light transmission part forming a light image of an object by light from the object, the light having passed through a transparent zone that transmits light, and that blocks light in a portion other than the transparent zone, in which the transparent zone is formed such that resolution of a light image formed in a direction different from a normal direction of a plate surface of the optical element plate with respect to the light transmission part is higher than resolution of a light image formed in the normal direction.

An optical device according to a second aspect of the present technology is an optical device including: an imaging element; and an optical element disposed at a position facing a light receiving surface of the imaging element, in which the optical element includes an optical element plate that includes, in part, a light transmission part forming a light image of an object by light from the object, the light having passed through a transparent zone that transmits light, and that blocks light in a portion other than the transparent zone, in which the transparent zone is formed such that resolution of a light image formed in a direction different from a normal direction of a plate surface of the optical element plate with respect to the light transmission part is higher than resolution of a light image formed in the normal direction.

The optical device according to the second aspect of the present technology includes: an imaging element; and an optical element disposed at a position facing a light receiving surface of the imaging element, in which the optical element includes an optical element plate that includes, in part, a light transmission part forming a light image of an object by light from the object, the light having passed through a transparent zone that transmits light, and that blocks light in a portion other than the transparent zone, and the transparent zone is formed such that resolution of a light image formed in a direction different from a normal direction of a plate surface of the optical element plate with respect to the light transmission part is higher than resolution of a light image formed in the normal direction.

### BRIEF DESCRIPTION OF DRAWINGS

FIG. 1 is a block diagram illustrating a configuration example of an optical device according to a first embodiment of the present technology.

FIG. 2 is a bottom view illustrating the optical element from a light receiving surface side of an imaging element.

FIG. 3 is a cross-sectional view taken along a line A-A in FIG. 2.

FIG. 4 is a diagram exemplifying an arrangement example 1 of light transmission parts of optical element plates in a case where the present technology is not applied.

FIG. 5 is a diagram exemplifying an arrangement example 2 of the light transmission parts of the optical element plates in a case where the present technology is applied.

FIG. 6 is a diagram used to describe an effect of the arrangement example 2 in FIG. 5.

FIG. 7 is a diagram used to describe an effect of the arrangement example 2 in FIG. 5.

FIG. 8 is a diagram for describing a shape of a transparent zone in a light transmission part to which the present technology is applied.

FIG. 9 is a diagram for describing a shape of the transparent zone in the light transmission part to which the present technology is applied.

FIG. 10 is a reference diagram accurately representing a boundary line rₙ of Formula (1).

FIG. 11 is a diagram for describing a form in which a photon sieve is modified as a form of the transparent zone of the light transmission part.

FIG. 12 is a bottom view illustrating an optical element from a light receiving surface side of an imaging element.

FIG. 13 is a cross-sectional view taken along a line B-B in FIG. 12.

FIG. 14 is a view exemplifying a case where the present technology is applied to a smartphone.

FIG. 15 is a view exemplifying a case where the present technology is applied to the smartphone.

FIG. 16 is a view exemplifying a case where the present technology is applied to smart glasses.

FIG. 17 is a view exemplifying a case where the present technology is applied to a door in an entrance or the like.

FIG. 18 is a view exemplifying a case where the present technology is applied to an abnormality watching sensor.

FIG. 19 is a view exemplifying a case where the present technology is applied to a tactile sensor.

FIG. 20 is a view exemplifying a case where the present technology is applied to the tactile sensor.

### MODE FOR CARRYING OUT THE INVENTION

Hereinafter, embodiments of the present technology will be described with reference to the drawings.

### <<Optical Device According to First Embodiment of Present Technology>>

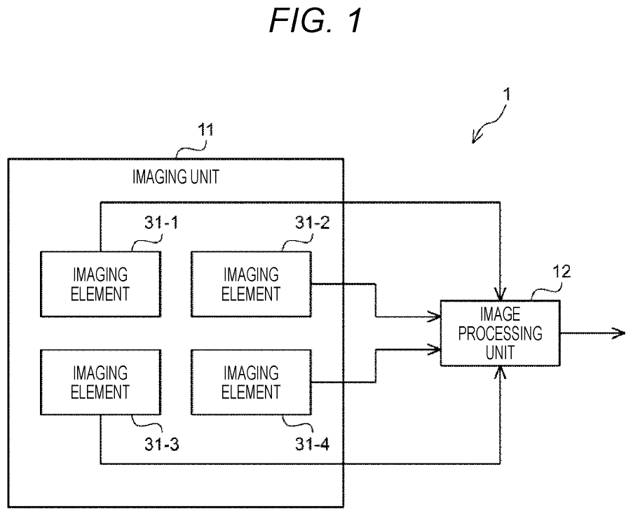

FIG. 1 is a block diagram illustrating a configuration example of an optical device according to a first embodiment of the present technology. In FIG. 1, an optical device 1 includes an imaging unit 11 and an image processing unit 12. The imaging unit 11 includes imaging elements 31-1 to 31-4 each including an optical element that forms a light image of a subject. The number of the imaging elements 31-1 to 31-4 is an example and is not limited to four. The imaging elements 31-1 to 31-4 may be complementary metal oxide semiconductor (CMOS) image sensors or charge coupled device (CCD) image sensors, and are not limited to a specific type. In a case where the imaging elements 31-1 to 31-4 are not distinguished from each other, they are simply referred to as imaging elements 31. The imaging elements 31-1 to 31-4 synchronously capture images of subjects in respective angle of view ranges in different directions. The imaging elements 31-1 to 31-4 supply captured images to the image processing unit 12.

The image processing unit 12 combines (joins together) images synchronously captured by the respective imaging elements 31-1 to 31-4 having different imaging directions. With this arrangement, for images for one frame respectively captured by each of the imaging elements 31-1 to 31-4, image regions having a common angle of view range (subject range) are integrated into one to generate a wide-angle image for one frame. The image generated by the image processing unit 12 is supplied to a processing unit at a subsequent stage (not illustrated) or an external device (not illustrated) separate from the optical device 1. Note that the image captured by each imaging element 31 may be a still image including an image for one frame, or may be a moving image including images repeatedly captured for every frame at predetermined time intervals. In a case where the image captured by each imaging element 31 is a still image, the image processing unit 12 generates a wide-angle image corresponding to one frame. In a case where the image captured by each imaging element 31 is a moving image, the image processing unit 12 generates a wide-angle image for every consecutive frame. Processing in a processing unit at a not-illustrated subsequent stage to which an image is supplied from the image processing unit 12 or processing in a not-illustrated external device is not limited to specific processing. Some processing and all processing in the image processing unit 12 may be performed by the imaging unit 11 (imaging element 31).

### <Configuration Example of Optical Element>

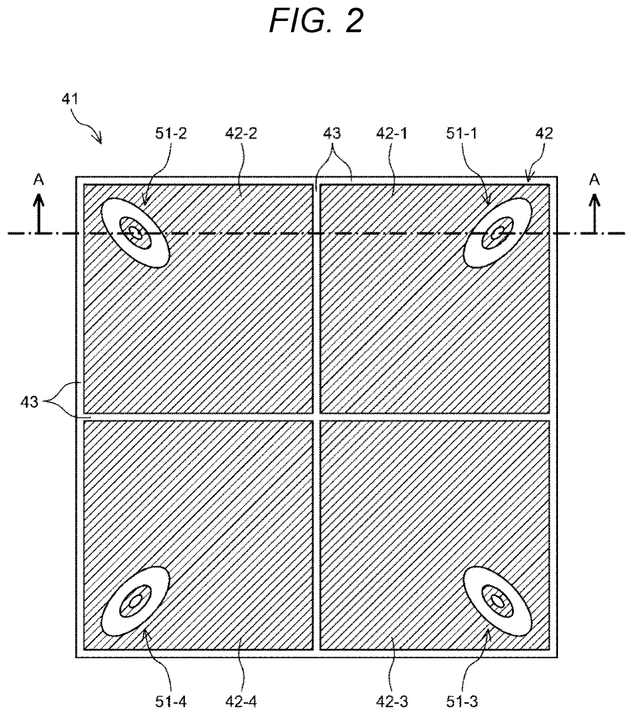

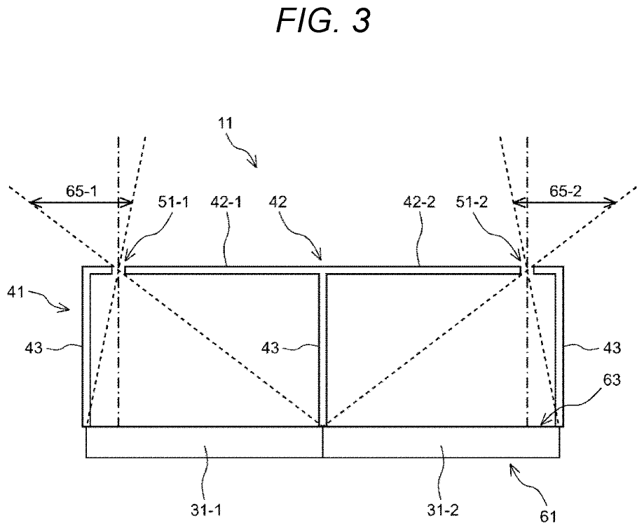

FIGS. 2 and 3 are views exemplifying the optical element (image forming optical element) included in each imaging element 31, FIG. 2 is a bottom view illustrating the optical element from the light receiving surface side of the imaging element 31, and FIG. 3 is a cross-sectional view taken along a line A-A in FIG. 2.

In FIGS. 2 and 3, an optical element 41 includes an optical element array 42 and a light shielding wall 43. The optical element array 42 is formed in a flat thin plate shape as a whole. The optical element array 42 is disposed on the light receiving surface side of an imaging element array 61 including the imaging elements 31-1 to 31-4 aligned in an array. The optical element array 42 includes a plurality of optical element plates 42-1 to 42-4 aligned in an array. Correspondingly to each of the imaging elements 31-1 to 31-4 of the imaging element array 61, the optical element plates 42-1 to 42-4 are each disposed at positions facing the respective light receiving surfaces. Note that the entire optical element array 42 may be integrally formed, or the optical element plates 42-1 to 42-4 may be separably connected along a flat surface. The optical element array 42 may be formed as a part of an optional member used in other applications such as a housing of a device in which the imaging unit 11 is disposed.

In each of the optical element plates 42-1 to 42-4, light transmission parts 51-1 to 51-4 each having a transparent zone through which light is transmitted are formed. Each of the light transmission parts 51-1 to 51-4 has a transparent zone in a form corresponding to the type of various lensless image forming optical elements such as a pinhole, a zone plate such as a Fresnel zone plate, and a photon sieve. Here, a point at which a straight line connecting an object point and an image point formed by the image forming optical element with respect to the object point intersects a surface (plate surface) of the optical element plate is referred to as a principal point, and a transparent zone formed in a region including a position of the principal point (principal point position) among one or a plurality of transparent zones included in each of the optical element plates 42-1 to 42-4 is referred to as a center transparent zone. At this time, any type of lensless image forming optical element has a center transparent zone. In FIG. 2, as the light transmission parts 51-1 to 51-4, a form of a Fresnel zone plate including a center transparent zone and an annular transparent zone surrounding the center transparent zone is exemplified, but the type of each of the optical element plates 42-1 to 42-4 is not limited to the Fresnel zone plate. Meanwhile, in FIG. 3, a form of a pinhole having one transparent zone (center transparent zone) at a principal point position is exemplified as each of the light transmission parts 51-1 to 51-4. However, FIG. 3 is a view in which the form of the light transmission part of an optional type of image forming optical element is simplified by only illustrating the center transparent zone formed at the principal point position. Note that the transparent zone of the light transmission parts 51-1 to 51-4 may be a hole (opening) formed through the opaque optical element plates 42-1 to 42-4, or may be a portion where a transparent member is disposed. Portions of each of the optical element plates 42-1 to 42-4 other than the transparent zone are opaque zones through which light is not transmitted (light is blocked). Details of the light transmission parts 51-1 to 51-4 will be described later.

The light shielding wall 43 is a light shielding member disposed between the optical element array 42 and the imaging element array 61, and is disposed so as to surround the light receiving surface of each of the imaging elements 31-1 to 31-4. That is, the light shielding wall 43 defines a region of a light image formed by each of the optical element plates 42-1 to 42-4 of the optical element array 42. Note that the light receiving surface of each of the imaging elements 31-1 to 31-4 is disposed along a position to be an image surface 63 of the optical element array 42. This light shielding wall 43 blocks the light passing through the light transmission part 51-n (n is any number from 1 to 4) of the optional optical element plate 42-n of the optical element array 42 from entering the light receiving surface of the imaging element 31-m (m is a number among 1 to 4 other than n) facing the other optical element plates 42-m. Therefore, in the cross section of FIG. 3, only the light that has arrived from a range of an angle of view 65-1 to the light transmission part 51-1 of the optical element plate 42-1 and transmitted therethrough is incident on the light receiving surface of the imaging element 31-1. Only the light that has arrived from a range of an angle of view 65-2 to the light transmission part 51-2 of the optical element plate 42-2 and transmitted therethrough is incident on the light receiving surface of the imaging element 31-2. Note that the light shielding wall 43 may be integrally formed with the optical element array 42 or may be a separate body. Furthermore, the light shielding wall 43 may not be in contact with any one or both of the optical element array 42 and the imaging element array 61. In a case where there is a gap between the light shielding wall 43 and the imaging element array 61 or in a case where a member having no light shielding properties is interposed therebetween, there is a possibility that the light images formed by the light transmission parts 51-1 to 51-4 overlap each other depending on the thickness of the light shielding wall 43. In that case, the image of the overlapped portion may not be used, or the portion may be repaired by performing an inverse operation from the optical characteristics.

### <Form of Light Transmission Part of Optical Element Plate>

### (Arrangement of Light Transmission Parts)

The forms of the light transmission parts 51-1 to 51-4 of the optical element plates 42-1 to 42-4 will be described. First, the arrangement of the light transmission parts 51-1 to 51-4 will be described by using the arrangement of the light transmission parts 51-1 and 51-2 of the optical element plates 42-1 and 42-2 as an example.

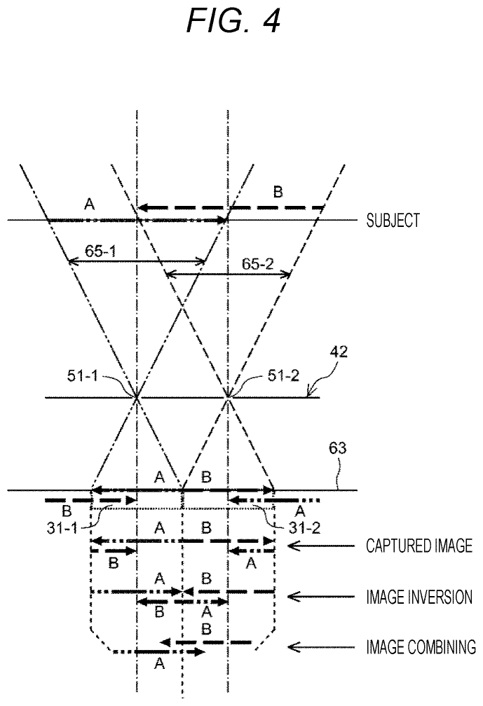

FIG. 4 is a diagram exemplifying an arrangement example 1 of the light transmission parts 51-1 and 51-2 of the optical element plates 42-1 and 42-2 in a case where the present technology is not applied. In FIG. 4, the light transmission parts 51-1 and 51-2 of the optical element plates 42-1 and 42-2 of the optical element array 42 are shown as one transparent zone. In the arrangement example 1, the light transmission parts 51-1 and 51-2 are disposed at positions facing the centers of the light receiving surfaces of the imaging elements 31-1 and 31-2 disposed at the position of the image surface 63 of the optical element array 42, respectively. Note that, in FIG. 4, the light shielding wall 43 is omitted. In this case, the optical element plates 42-1 and 42-2 form the light images of the subject in the range of the angles of view 65-1 and 65-2 in FIG. 4 on the light receiving surfaces of the imaging elements 31-1 and 31-2, respectively. For example, it is assumed that a subject A indicated by an arrow is present in the entire range of the angle of view 65-1 and a subject B indicated by an arrow is present in the entire range of the angle of view 65-2. In this case, assuming that there is no light shielding wall 43, the optical element plates 42-1 and 42-2 form images by reversing the directions of the light images of the subject A and the subject B with respect to the image surface 63. The imaging elements 31-1 and 31-2 each acquire a light image of the subject A and a light image of the subject B formed in the range of the light receiving surface as captured images. The captured image acquired by the imaging element 31-1 includes the entire subject A and a part of the subject B as subjects in the range of the angle of view 65-1. The captured image acquired by the imaging element 31-2 includes the entire subject B and a part of the subject A as subjects in the range of the angle of view 65-2. The captured images acquired by the imaging elements 31-1 and 31-2 are supplied to the image processing unit 12 in FIG. 1, and image inversion and image combining processing are performed. In the image inversion processing, the captured image is vertically and horizontally inverted. However, the image inversion processing in the image processing unit 12 is unnecessary in a case where the image inversion is performed by control or the like of the reading order of pixel data from the imaging elements 31-1 and 31-2. In the image combining processing, among the image regions of the respective captured images from the imaging elements 31-1 and 31-2, images of image regions corresponding to a common angle of view range are integrated into one and combined as a wide-angle image for one frame. As a simple example of the image combining processing, images are cut out from the respective captured images from the imaging elements 31-1 and 31-2 so that the angle of view ranges do not overlap each other and are continuous, and the images are joined together to generate a wide-angle image. In FIG. 4, the image regions including both the subject A and the subject B are images having a common angle of view range, and thus are integrated as an image of one image region. For example, the image having the common angle of view range may be an image of only one of the captured images of the imaging elements 31-1 and 31-2, or may be an average image of both of the images, and is not limited to the case of being generated by a specific method.

According to the arrangement example 1 described above, the range (angle of view range) of the subject to be imaged is enlarged in the direction in which the light transmission parts are aligned, as compared with the case of imaging the subject by using the optical element including only one light transmission part.

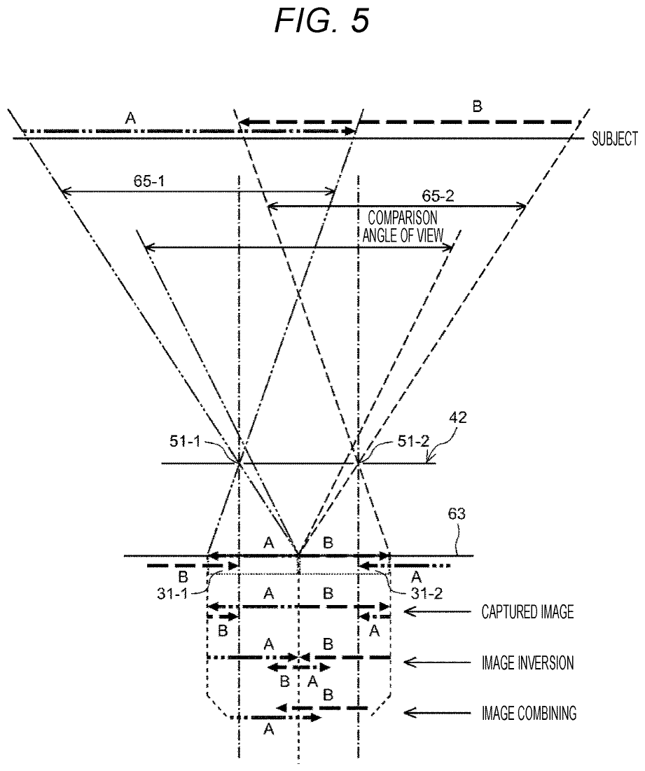

FIG. 5 is a diagram exemplifying an arrangement example 2 of the light transmission parts 51-1 and 51-2 of the optical element plates 42-1 and 42-2 in a case where the present technology is applied. Note that only differences from the arrangement example 1 in FIG. 4 will be described.

In the arrangement example 2 in FIG. 5, the light transmission parts 51-1 and 51-2 are disposed at positions spaced apart from each other from positions facing the centers of the light receiving surfaces of the imaging elements 31-1 and 31-2. In this case, the optical element plates 42-1 and 42-2 form the light images of the subject in the range of the angles of view 65-1 and 65-2 in FIG. 5 on the light receiving surfaces of the imaging elements 31-1 and 31-2, respectively. Here, the angles of view 65-1 and 65-2 in FIG. 5 are changed such that an angle difference between the directions (imaging directions) of the angles of view becomes large as compared with the case of the arrangement example 1 in FIG. 4. Therefore, in a case where the imaging elements 31-1 and 31-2 acquire the light image of the subject A and the light image of the subject B formed in the range of the light receiving surface as captured images, respectively, a ratio of the subject B included in the captured image acquired by the imaging element 31-1 to the entire subject B is smaller than that in the case of the arrangement example 1 in FIG. 4. Similarly, a ratio of the subject A included in the captured image acquired by the imaging element 31-2 to the entire subject A is smaller than that in the case of the arrangement example 1 in FIG. 4. That is, the ratio of the image regions in the common angle of view range in the captured images acquired by the imaging elements 31-1 and 31-2 is smaller than that in the case of the arrangement example 1 in FIG. 4.

The captured images acquired by the imaging elements 31-1 and 31-2 are supplied to the image processing unit 12 in FIG. 1, and image inversion and image combining processing are performed. As a result, a wide-angle image is generated by combining the respective captured images from the imaging elements 31-1 and 31-2. At this time, the image region corresponding to the common angle of view range with respect to the entire image region of the respective captured images from the imaging elements 31-1 and 31-2 is smaller than the case of the arrangement example 1 in FIG. 4. Therefore, the angle of view of the combined image is larger than that in the case of the arrangement example 1 in FIG. 4 (comparison angle of view in FIG. 5).

According to the arrangement example 2 described above, the range (angle of view range) of the subject to be imaged is enlarged in the direction in which the light transmission parts are aligned, as compared with the case of the arrangement example 1. Because the size of the image regions corresponding to the common angle of view among the image regions of the captured images captured by the plurality of imaging elements becomes small, the captured images captured by the plurality of imaging elements are effectively used. Note that, according to the arrangement example 2, as will be described later, the captured images acquired by the imaging elements 31-1 and 31-2 have substantially no image region corresponding to the common angle of view range, and can form an image corresponding to different continuous angle of view ranges. In this case, in the image combining processing, the image combining processing can be simple processing of simply joining together the captured images (captured images after image inversion) acquired by the imaging elements 31-1 and 31-2.

In FIG. 2, for example, the position of the optical element array 42 facing the center of the light receiving surface of the imaging element array 61 including the plurality of imaging elements 31-1 to 31-4 is assumed to be the center of the optical element array 42. At this time, as illustrated in FIG. 2, the light transmission parts 51-1 to 51-4 of the optical element plates 42-1 to 42-4 are each formed at a position farthest from the center of the optical element array 42 within a range in which the light transmission parts 51-1 to 51-4 can be formed in each of the optical element plates 42-1 to 42-4, or at least at a position farthest from the center of each of the optical element plates 42-1 to 42-4 with respect to the center of the optical element array 42. Furthermore, in a case where the imaging element array 61 is arranged vertically and horizontally symmetrically, the light transmission parts 51-1 to 51-4 are also arranged vertically and horizontally symmetrically, or the light transmission parts 51-1 to 51-4 are formed at positions where the common angle of view range or the continuous angle of view range is present in the angle of view range of vertically or horizontally adjacent imaging elements among each of the imaging elements 31-1 to 31-4. Even in a case where the imaging element array 61 and the optical element array 42 include imaging elements and optical element plates other than four, the light transmission parts are arranged under the similar conditions as in the case of four.

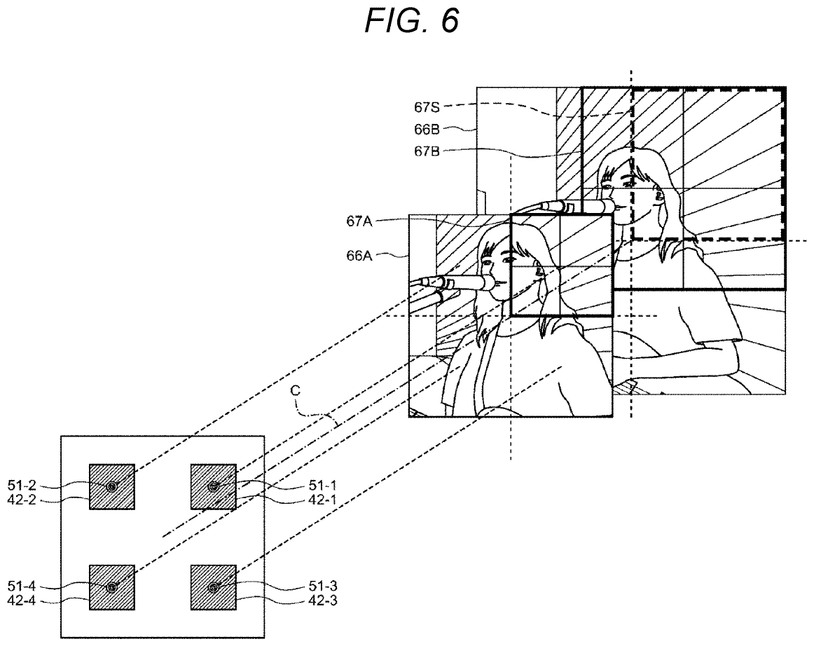

Next, effects of the arrangement example 2 in FIG. 5 will be described in comparison with other arrangement examples. FIG. 6 is a diagram exemplifying an arrangement example 3 of the light transmission parts 51-1 to 51-4 of the optical element plates 42-1 to 42-4 in a case where the present technology is not applied. In FIG. 6, the light transmission parts 51-1 and 51-4 of the optical element plates 42-1 to 42-4 are disposed at positions facing the centers of the light receiving surfaces of the imaging elements 31-1 to 31-4 (not illustrated) corresponding to the optical element plates 42-1 to 42-4, respectively, similarly to the arrangement example 1 in FIG. 4. However, the imaging elements 31-1 to 31-4 and the optical element plates 42-1 to 42-1 disposed to face the light receiving surface light of the imaging elements are disposed at positions separated from each other. For example, the imaging elements 31-1 to 31-4 and the optical element plates 42-1 to 42-4 may be mounted on separate optical devices (camera devices).

According to the arrangement example 3, because the angle of view ranges of the captured images captured by the respective imaging elements 31-1 to 31-4 are different, a wide-angle image is generated by combining the captured images. In FIG. 6, subjects 66A and 66B represent a part of the same planar photograph (or picture), and are disposed at different distances from the optical element plates 42-1 to 42-4, respectively. The images of the subjects 66A and 66B drawn in FIG. 6 represent only the images of the ranges of the subjects 66A and 66B (referred to as the entire imaging range of the subject 66A or 66B) included in the angle of view range of any of the imaging elements 31-1 to 31-4 among the original entire ranges of the subjects 66A and 66B, respectively, and the images of the ranges of the subjects 66A and 66B that are not imaged by any of the imaging elements 31-1 to 31-4 are omitted. The subject 66A represents a case where the ranges of the subject 66A imaged by the respective imaging elements 31-1 to 31-4 do not overlap each other and are disposed at distances (positions) that form a continuous range (range without a gap). At this time, for example, the imaging element 31-1 corresponding to the optical element plate 42-1 captures an image of an imaging range 67A among the entire imaging range of the subject 66A. The imaging range 67A is one imaging range obtained by dividing (equally dividing) the entire imaging range of the subject 66A into four imaging ranges of 2×2. The other three imaging ranges are imaged by the imaging elements 31-2 to 31-4, respectively. In the image combining processing, a wide-angle image is generated by joining the captured images captured by the respective imaging elements 31-1 to 31-4.

The subject 66B is shown in a case of being disposed at a position more distant than the subject 66A with respect to the optical element plates 42-1 to 42-4. At this time, for example, the imaging element 31-1 corresponding to the optical element plate 42-1 captures an image of an imaging range 67B among the entire imaging range of the subject 66B. The imaging range 67B includes one imaging range obtained by dividing the entire imaging range of the subject 66B into four imaging ranges of 2×2 and a part of the other imaging range. Similarly to the imaging element 31-1, each of the other imaging elements 31-2 to 31-4 captures an image of an imaging range including one of the four divided imaging ranges and a part of the other imaging range. In the image combining processing, for example, an image in a cut-out range 67S is cut out from the captured image in the imaging range 67B captured by the imaging element 31-1. The cut-out range 67S is one of four imaging ranges obtained by dividing the entire imaging range of the subject 66B. In this manner, the images in the cut-out ranges are cut out from the captured images captured by the imaging elements 31-1 to 31-4 and joined together to generate a wide-angle image. Here, the size of the cut-out range 67S with respect to the imaging range 67B of the imaging element 31-1 varies depending on the distance of the subject 66B, and decreases as the distance increases. Because the distance of the subject 66B is unknown, it is not easy to identify the cut-out range. Therefore, in the image combining processing, processing of identifying an image region in which imaging ranges (angle of view ranges) overlap each other by comparing captured images captured by the imaging elements 31-1 to 31-4 is required, and the image combining processing becomes complicated.

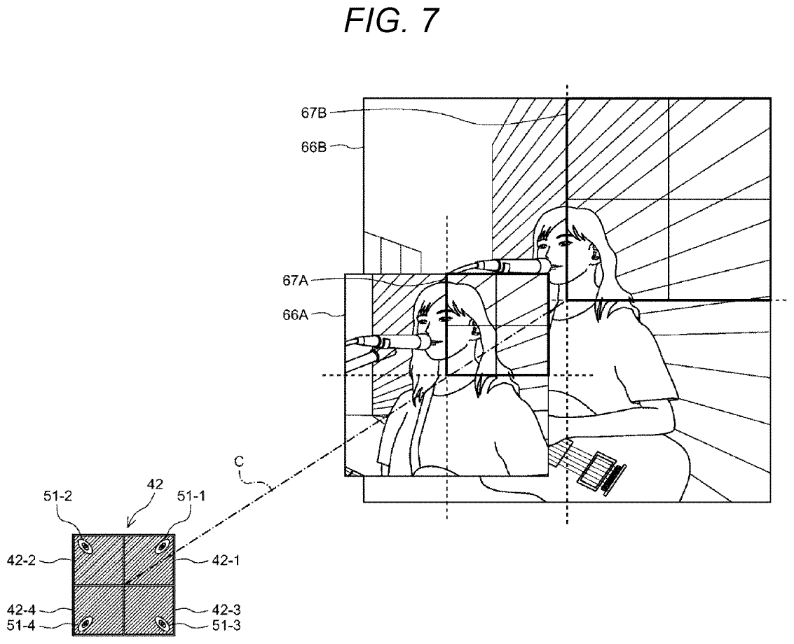

FIG. 7 is a diagram exemplifying the arrangement example 2 of the light transmission parts 51-1 to 51-4 of the optical element plates 42-1 to 42-4 in a case where the present technology is applied. Note that the arrangement example 2 in FIG. 7 represents a case where the arrangement example 2 described in FIG. 5 is extended to the arrangement of the four light transmission parts 51-1 to 51-4. Here, the description of the arrangement of the light transmission parts 51-1 to 51-4 of the optical element plates 42-1 to 42-4 in the optical element array 42 will be omitted, and only differences from the arrangement example 3 in FIG. 6 will be described.

In FIG. 7, the subjects 66A and 66B represent a part of the same planar photograph (or picture) similarly to FIG. 6, and are disposed at different distances from the optical element plates 42-1 to 42-4, respectively. The subject 66B is farther away than the subject 66A. The images of the subjects 66A and 66B drawn in FIG. 7 represent the images of the ranges of the subjects 66A and 66B (the entire imaging range of the subject 66A or 66B) included in the angle of view range of any of the imaging elements 31-1 to 31-4 among the original entire ranges of the subjects 66A and 66B, respectively, and the images of the ranges of the subjects 66A and 66B that are not imaged by any of the imaging elements 31-1 to 31-4 are omitted.

According to the arrangement example 2, the imaging range of each of the imaging elements 31-1 to 31-4 is one imaging range obtained by dividing the entire imaging range of each of the subjects 66A and 66B into four imaging ranges, regardless of the distances of the subjects 66A and 66B with respect to the optical element plates 42-1 to 42-4. For example, the imaging element 31-1 corresponding to the optical element plate 42-1 captures an image of the imaging range 67A among the entire imaging range of the subject 66A. The imaging range 67A is one imaging range obtained by dividing the entire imaging range of the subject 66A into four imaging ranges of 2×2. The other three imaging ranges are imaged by the imaging elements 31-2 to 31-4, respectively. Similarly, the imaging element 31-1 captures an image of the imaging range 67B in the entire imaging range of the subject 66B. The imaging range 67B is one imaging range obtained by dividing the entire imaging range of the subject 66B into four imaging ranges of 2×2. The other three imaging ranges are imaged by the imaging elements 31-2 to 31-4, respectively.

More specifically, an axis that passes through the center of the optical element array 42 and is the normal direction with respect to the plate surface on which the optical element plates 42-1 to 42-4 are disposed is defined as an axis C of the optical element array 42. Furthermore, an axis that passes through the principal point position of each of the light transmission parts 51-1 to 51-4 of the optical element plates 42-1 to 42-4 and is in the normal direction with respect to the plate surface is defined as an optical axis of each of the optical element plates 42-1 to 42-4.

Meanwhile, it can be assumed that the distance between the light transmission parts 51-1 to 51-4 of the optical element plates 42-1 to 42-4 is, for example, on the order of millimeters, and as compared with this, the distance between the subjects 66A and 66B is sufficiently long. Therefore, the optical axis of each of the optical element plates 42-1 to 42-4 can be considered to coincide with the axis C of the optical element array 42.

Furthermore, assuming that a point on the light receiving surface of each of the imaging elements 31-1 to 31-4 intersecting the optical axes of the optical element plates 42-1 to 42-4 is a reference point on which the object point on the axis C is formed, an azimuth (direction around the axis C) and an angle (angle formed by the axis C and a straight line connecting the center of the optical element array 42 and the object point) with respect to the axis C of the object point formed at each point on the light receiving surface of each of the imaging elements 31-1 to 31-4 are determined by the azimuth and the distance of each point on the light receiving surface with respect to the reference point. The azimuth of the object point formed on each point on the light receiving surface with respect to the axis C is an azimuth opposite to the azimuth of each point on the light receiving surface with respect to the reference point by 180 degrees. The angle of the object point formed at each point on the light receiving surface with respect to the axis C is an angle (the greater the distance, the greater the angle) according to the distance from the reference point of each point on the light receiving surface. Therefore, the imaging range (angle of view range) of the imaging element 31-1 is determined by the position of the reference point on the light receiving surface, that is, the light transmission part 51-1.

Focusing on the imaging range (angle of view range) of the imaging element 31-1, because the light transmission part 51-1 of the optical element plate 42-1 is provided, for example, in the vicinity of the corner farthest from the center of the optical element array 42, the reference point on the light receiving surface of the imaging element 31-1 is in the vicinity of the corner farthest from the center of the optical element array 42 among the four corners on the light receiving surface (that is, in the vicinity of the upper right corner in FIG. 7, which is in a diagonal relationship with the corner of the light receiving surface facing substantially the center of the optical element array 42). Therefore, the imaging range of the imaging element 31-1 is limited approximately to the azimuth from the right direction to the upper direction in FIG. 7 with respect to the axis C. Therefore, with respect to the subject 66A, the imaging range of the imaging element 31-1 is the imaging range 67A, which is one of the four imaging ranges obtained by dividing the entire imaging range of the subject 66A with the intersection with the axis C as the center. With respect to the subject 66B, the imaging range is the imaging range 67B, which is one of the four imaging ranges obtained by dividing the entire imaging range of the subject 66B with the intersection with the axis C as the center. The imaging ranges of the other imaging elements 31-2 to 31-4 are also similar to the imaging range of the imaging element 31-1.

According to the arrangement example 2, in the image combining processing, the cut-out range can be identified regardless of the distance of the subject on the basis of the position of the reference point on the light receiving surface such that the imaging ranges (angle of view ranges) do not overlap each other, with respect to the captured images captured by the respective imaging elements 31-1 to 31-4, and a wide-angle image can be generated by joining the captured images of the cut-out ranges. In particular, in a case where the light transmission parts 51-1 to 51-4 of the optical element plates 42-1 to 42-4 are formed at positions facing the corners of the light receiving surfaces of the imaging elements 31-1 to 31-4, a wide-angle image can also be generated by directly joining the captured images without having a part of the images cut out from the captured images captured by the imaging elements 31-1 to 31-4. Therefore, according to the arrangement example 2, the image combining processing can be easily performed.

### (Form of Transparent Zone of Light Transmission Part)

Next, the form (shape) of the transparent zone of the light transmission parts 51-1 to 51-4 will be described. Note that the light transmission parts 51-1 to 51-4 will be referred to as light transmission parts 51 in a case where the light transmission parts are not distinguished from each other. In a general case, in various lensless image forming optical elements such as a pinhole, a zone plate, and a photon sieve, the resolution is highest in a light image formed in the normal direction with respect to the plate surface from the position (principal point position) of the light transmission part. Meanwhile, in the case of the arrangement example 2 in FIG. 5 to which the present technology is applied, a light image formed in the oblique direction with respect to the plate surface from the principal point position of the light transmission part is the center of the light receiving surface of the imaging element. Therefore, the resolution of the light image in the vicinity of the center of the light receiving surface becomes low, and in a case where a plurality of captured images is combined by image combining processing, there is a case where the resolution varies depending on the position of the combined image and the combined image having a non-uniform resolution is generated. Therefore, in the light transmission part to which the present technology is applied, a transparent zone is formed, the transparent zone having a shape in which a light image having the highest resolution is formed near the center of the light receiving surface of the imaging element. Note that, although the zone plate mainly represents a Fresnel zone plate, the zone plate also includes an image forming optical element having an imaging function in a case where the shape of the transparent zone does not correspond to the Fresnel zone plate.

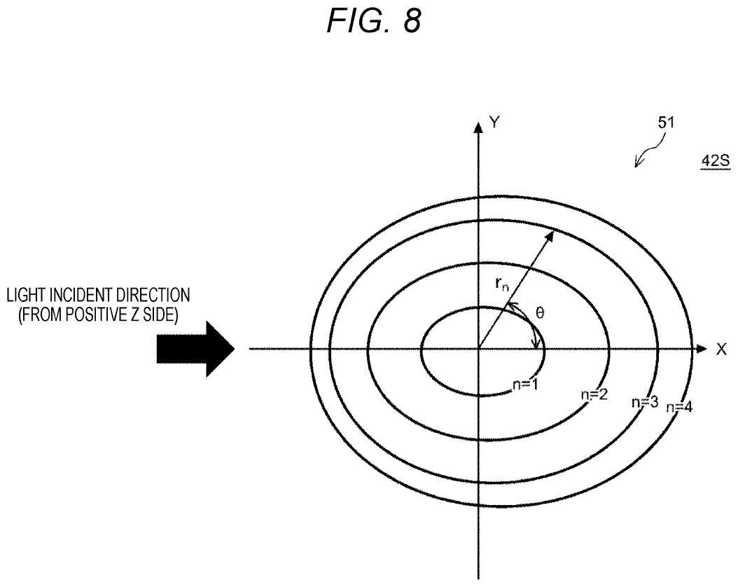

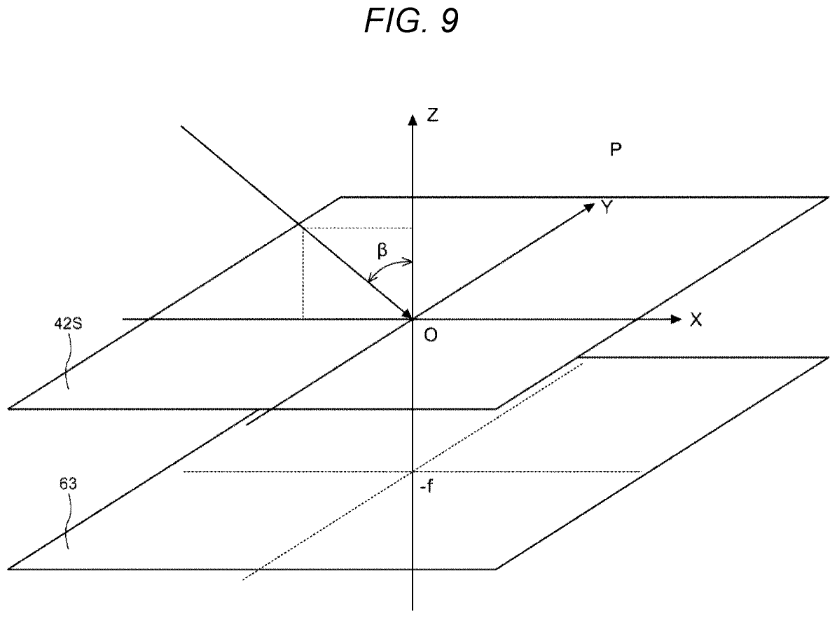

FIGS. 8 and 9 is a diagram for describing the shape of the transparent zone in the light transmission part to which the present technology is applied. In FIG. 8, the origin of the XY coordinates represents the principal point position of the light transmission part 51, and the X axis and the Y axis represent directions along a plate surface 42S of the optical element plate (optical element array 42) in which the light transmission part 51 is formed. The X axis represents a direction in which a direction that the light transmission part 51 forms a light image having the maximum resolution is projected on the plate surface 42S. The Y axis represents a direction orthogonal to the X axis. In FIG. 9, the Z axis represents a direction orthogonal to the plate surface 42S. An incident angle β represents an angle formed between the Z axis and light (also referred to as light for forming the light image with the maximum resolution) directed in a direction in which a light image with the maximum resolution is formed among the light (light beam) incident on the principal point position. Because the light incident on the principal point position travels straight through the light transmission part 51, the incident angle β is also an angle formed between the Z axis and the light traveling from the principal point position to the position on the image surface 63 where the light image with the maximum resolution is formed. Assuming that the plate surface 42S and the image surface 63 are parallel to each other and the distance (focal length of the optical element) therebetween is f (positive value), the plate surface 42S is represented as a plane having a Z coordinate value of 0, whereas the image surface 63 is represented as a plane having a Z coordinate value of −f. Note that the position where the light image having the maximum resolution is formed is assumed to be the position of the XYZ coordinate value represented by (f·tan β,0,−f).

At this time, in a case where a boundary line of the transparent zone of the light transmission part 51 illustrated in FIG. 8 is represented by polar coordinates (rₙ,θ) (n is an integer of 0 or more), rₙ is calculated by the following Formula (1) as a function of θ.

$$\begin{matrix}[ Math . 1 ] & \\ {r}_{n} = \frac{- AB + \sqrt{- 2 {A}^{2} BL + {B}^{2} + 2 BL}}{1 - {A}^{2}} & ( 1 )\end{matrix}$$

Here, sin β·cos θ=A, (n+α)·λ/2=B, f/cos β=L, and λ is a center wavelength of light to be condensed.

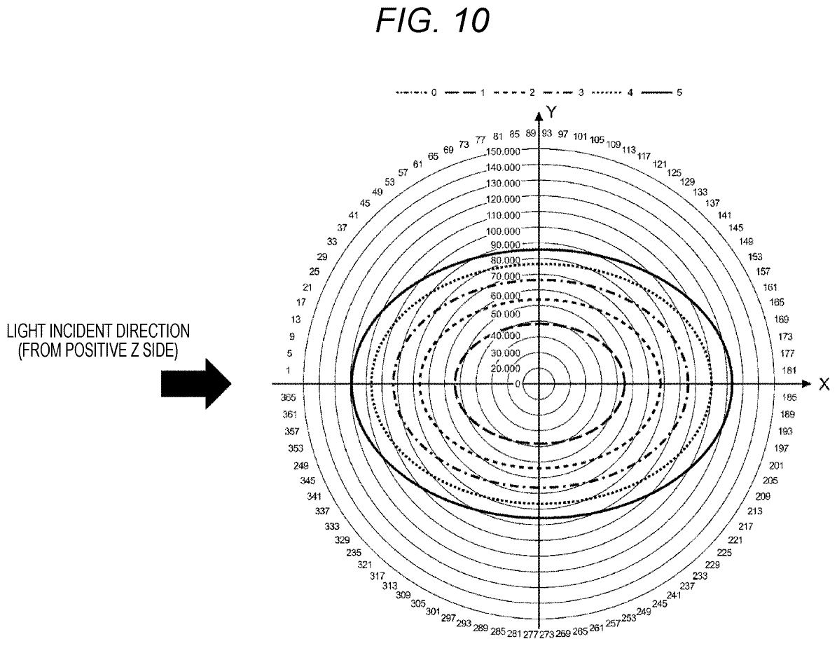

Assuming that rₙ (referred to as a boundary line rₙ) is an annular line and the boundary line rₙ in the case of n=0 represents the origin (principal point position), a region between the boundary line rₙ (inner boundary line) of n=2i (i is an integer of 0 or more) and the boundary line rₙ (outer boundary line) of n=2i+1 is formed as the transparent zone. Note that α is an adjustment value, and the position of the boundary line r₁ particularly greatly changes depending on α. FIG. 10 is a reference diagram accurately representing the boundary line rₙ of Formula (1).

FIG. 2 illustrates the light transmission parts 51-1 to 51-4 in which a transparent zone in a case where α=0 and i=0, that is, a transparent zone (center transparent zone) in a region on the inner side of the boundary line r₁ of n=1 including the origin with the boundary line r₀ of n=0 as an origin, and a transparent zone in a case where α=0 and i=1, that is, a transparent zone in a region between the boundary line r₂ (inner side) of n=2 and the boundary line r₃ (outer side) of n=3, are formed. As described above, the light transmission part 51 in which a plurality of transparent zones in which i is from 0 to an optional value is formed corresponds to a form in which the Fresnel zone plate is deformed.

Qualitatively, as compared with the transparent zone of a normal Fresnel zone plate, the boundary line rₙ has an elongated shape (shape elongated in one direction) with respect to the incident direction (X axis direction) of the light forming the light image with the maximum resolution. Furthermore, the elongated shape has a shape in which the light emitting side is more extended than the light incident side (a shape in which the opposite direction to the principal point position is more extended than one direction). For example, as illustrated in FIGS. 8 and 9, in a case where the light that forms the light image with the maximum resolution is incident on the light transmission part 51 from the negative direction of the X axis, rₙ, which is the distance from the origin, is longer in the X axis direction than in the Y axis direction. Furthermore, rₙ is longer in the positive region than in the negative region on the X axis. Note that the boundary line rₙ is line symmetric with respect to X=0,
but is not line symmetric with respect to Y=0.

For example, after the principal point positions of the light transmission parts 51-1 to 51-4 are determined in the optical element plates 42-1 to 42-4 as illustrated in FIG. 2, the position of the XYZ coordinates (f·tan β,0,−f) assumed as the position where the light image with the maximum resolution is formed is determined to be the center position of the light receiving surface of each of the imaging elements 31-1 to 31-4 facing each of the optical element plates 42-1 to 42-4, or at least a position closer to the center of the light receiving surface than the position on the light receiving surface facing the principal point position. With this configuration, in each of the optical element plates 42-1 to 42-4, the direction of the XYZ axes of the XYZ coordinates with the principal point position as the origin and the constant used in the above Formula (1) such as the incident angle β of light forming the light image with the maximum resolution are determined. As a result, a region where the transparent zone is formed in each of the optical element plates 42-1 to 42-4 is determined by the above Formula (1).

On the other hand, in the light transmission part 51 in which only the transparent zone in the case of α=0 and i=0, that is, only the transparent zone (center transparent zone) in the region on the inner side of the boundary line r₁ of n=1 including the origin with the boundary line r₀ of n=0 as the origin, is formed as the transparent zone of the light transmission part 51, the form of the light transmission part 51 corresponds to the form in which the pinhole is deformed. The light transmission part 51 may have such a form in which a pinhole is modified. In this case, as the value of α in the above Formula (1), for example, r₁ at θ=90° may be determined to be r₁=0.78·(λ·f)^{1/2}.

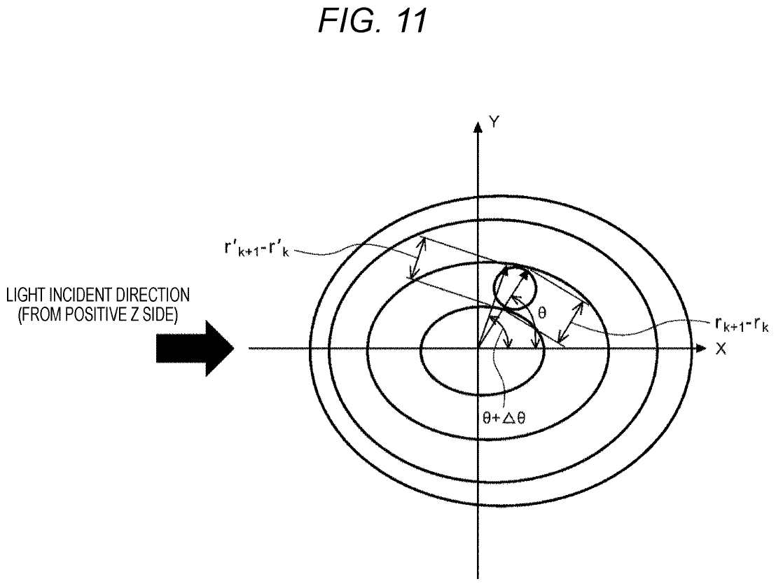

Furthermore, the form of the transparent zone of the light transmission part 51 may have the following form in which a photon sieve is modified. As illustrated in FIG. 11, with respect to the boundary line rₙ expressed by the above Formula (1), it is assumed that a value (distance from the origin) of the inner boundary line rₙ in an optional angle θ direction as a region where the transparent zone is formed is rₖ, and a value of the outer boundary line rₙ₊₁ of the region is rₖ₊₁. Assuming a case of a circle having a radius of 0.765. (rₖ₊₁-rₖ) centered on an intermediate position between the inner boundary line and the outer boundary line in the θ direction, a region of the circle is formed as a transparent zone. Such transparent zones are formed for various values of θ. However, the transparent zones (circles) are set not to overlap each other. Such a form of the light transmission part 51 corresponds to a form in which a photon sieve is modified. Furthermore, the following deformation may be applied to each circle in which the transparent zone is formed. As illustrated in FIG. 11, it is assumed that the center of the circle in which the transparent zone is formed is in the angle θ direction, the value of the inner boundary line rₙ is rₖ, and the value of the outer boundary line rₙn is rₖ₊₁. In a case where the angle θ is changed by Δθ, and
in a case where the value of the inner boundary line rₙ with respect to the angle θ+Δθ direction is rₖ′ and the value of the outer boundary line rₙ₊₁ is rₖ₊₁′, the width of the circle with respect to the angle θ+Δθ direction (interval between two intersections where a straight line in the angle θ+Δθ direction and the circle (contour) intersect) is deformed into a shape multiplied by (rₖ₊₁′−rₖ′)/(rₖ₊₁−rₖ) around the intermediate position between the inner boundary line rₙ and the outer boundary line rₙ₊₁ with respect to the angle θ+Δθ direction. Δθ is changed to a continuous value within a range in which the circle centered on the angle θ direction is present, and deformation is applied to the entire circle.

According to the form of the light transmission part 51 described above, the light image incident on the plate surface from an oblique direction and formed in the oblique direction can have the maximum resolution. Therefore, even in a case where the light image formed obliquely with respect to the plate surface from the principal point position of the light transmission part 51 becomes the center of the light receiving surface of the imaging element as in the arrangement example 2 in FIG. 5, the light image in the vicinity of the center of the light receiving surface or at an optional position can be set to have high resolution. In a case where a plurality of captured images is combined by image combining processing, the resolution can be made uniform over the entire combined image.

### <<Optical Device According to Second Embodiment of Present Technology>>

The optical device according to the second embodiment of the present technology has a form in a case where the number of imaging elements 31 of the imaging unit 11 in the optical device 1 of the first embodiment is increased from 4 to 16. A block diagram illustrating the configuration example of the optical device according to the second embodiment is common to the block diagram in FIG. 1 except that the number of imaging elements 31 of the imaging unit 11 in the optical device 1 in FIG. 1 is changed to 16. Therefore, the block diagram in FIG. 1 is the block diagram illustrating the configuration example of the optical device according to the second embodiment, and description thereof is omitted. Note that the imaging element of the imaging unit 11 in the second embodiment is represented by imaging elements 31-1 to 31-16. In a case where the imaging elements 31-1 to 31-16 are not distinguished from each other, they are simply referred to as imaging elements 31. Here, the number of imaging elements 31 is not limited to the case of 4 or 16, and, for example, may be any number such as 3×3=9 or 5×5=25. Furthermore, the numbers of the imaging elements 31 in the vertical direction and the horizontal direction may not be equal to each other, such as in a case where the arrangement of the imaging elements is 2× 4=8.

### <Configuration Example of Optical Element>

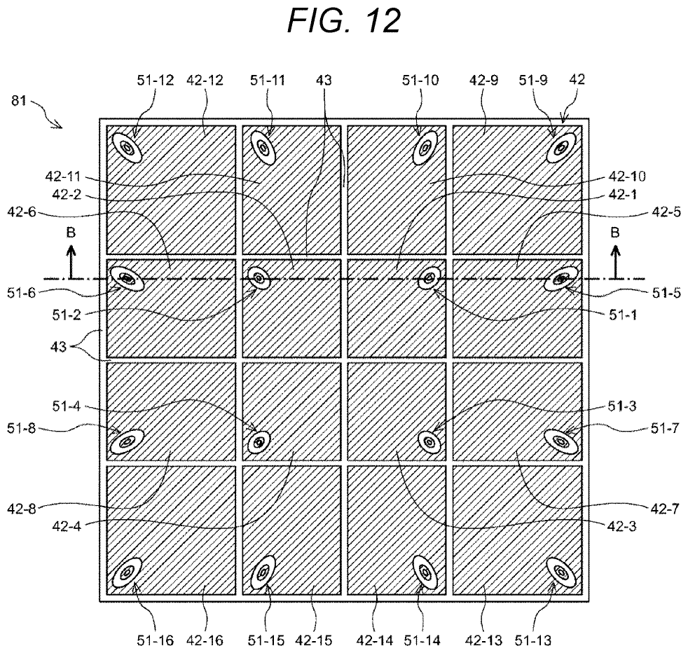

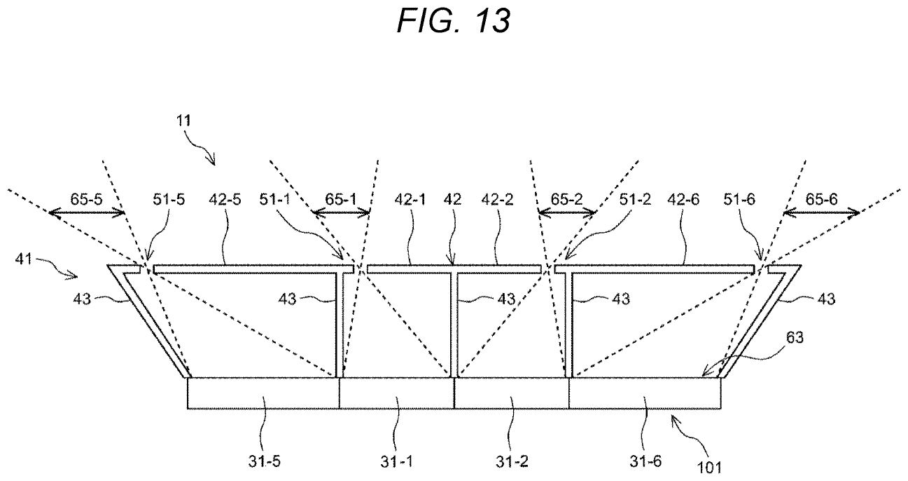

FIGS. 12 and 13 are views exemplifying the optical element (image forming optical element) included in each imaging element 31, FIG. 12 is a bottom view illustrating the optical element from the light receiving surface side of the imaging element 31, and FIG. 13 is a cross-sectional view taken along a line B-B in FIG. 12. Note that, in FIGS. 12 and 13, for the portions denoted by the same reference signs as those in FIGS. 2 and 3, the description common to the contents described in FIGS. 2 and 3 will be omitted, and only differences will be described.

In FIGS. 12 and 13, an optical element 81 includes an optical element array 42 and a light shielding wall 43. The optical element array 42 is disposed on the light receiving surface side of an imaging element array 61 including the imaging elements 31-1 to 31-16 aligned in an array. The optical element array 42 includes a plurality of optical element plates 42-1 to 42-16 arranged in an array. The optical element plates 42-1 to 42-16 are disposed at positions facing the respective light receiving surfaces corresponding to each of the imaging elements 31-1 to 31-16 of the imaging element array 61. Note that the entire optical element array 42 may be integrally formed, or the optical element plates 42-1 to 42-16 may be separably connected along a flat surface.

In each of the optical element plates 42-1 to 42-16, light transmission parts 51-1 to 51-16 each having a transparent zone through which light is transmitted are formed. Each of the light transmission parts 51-1 to 51-6 has a transparent zone in a form corresponding to the type of various lensless image forming optical elements such as a pinhole, a zone plate such as a Fresnel zone plate, and a photon sieve.

The light shielding wall 43 is a light shielding member disposed between the optical element array 42 and the imaging element array 61, and is disposed so as to surround the light receiving surface of each of the imaging elements 31-1 to 31-16. This light shielding wall 43 blocks the light passing through the light transmission part 51-n (n is any number from 1 to 16) of the optional optical element plate 42-n of the optical element array 42 from entering the light receiving surface of the imaging element 31-m (m is a number among 1 to 16 other than n) facing the other optical element plates 42-m. Therefore, in the cross section of FIG. 13, only the light that has arrived from a range of an angle of view 65-1 to the light transmission part 51-1 of the optical element plate 42-1 and transmitted therethrough is incident on the light receiving surface of the imaging element 31-1. Only the light that has arrived from a range of an angle of view 65-2 to the light transmission part 51-2 of the optical element plate 42-2 and transmitted therethrough is incident on the light receiving surface of the imaging element 31-2. Only the light that has arrived from a range of an angle of view 65-5 to the light transmission part 51-5 of the optical element plate 42-5 and transmitted therethrough is incident on the light receiving surface of the imaging element 31-5. Only the light that has arrived from a range of an angle of view 65-6 to the light transmission part 51-6 of the optical element plate 42-6 and transmitted therethrough is incident on the light receiving surface of the imaging element 31-6.

### <Form of Light Transmission Part of Optical Element Plate>

### (Arrangement of Light Transmission Parts and Form of Transparent Zone)

The arrangement of the light transmission parts 51-1 to 51-16 of the optical element plates 42-1 to 42-16 and the form of the transparent zone will be described. The arrangement of the light transmission parts 51-1 to 51-4 of the optical element plates 42-1 to 42-4 is the same as the arrangement of the light transmission parts 51-1 to 51-4 of the optical element plates 42-1 to 42-4 in the first embodiment described in the arrangement example 2 and the like in FIG. 5. The form of the transparent zone of the light transmission parts 51-1 to 51-4 is the same as the form of the transparent zone of the light transmission parts 51-1 to 51-4 in the first embodiment described in FIGS. 8 to 9.

The second embodiment is different from the first embodiment in that the imaging elements 31-5 to 31-16 and the optical element plates 42-5 to 42-16 are further disposed around the imaging elements 31-1 to 31-4 and the optical element plates 42-1 to 42-4.

The arrangement of the light transmission parts 51-5 to 51-16 of the optical element plates 42-5 to 42-16 is also determined according to the similar conditions as those of the light transmission parts 51-1 to 51-4 of the optical element plates 42-1 to 42-4. That is, the light transmission parts 51-5 to 51-16 of the optical element plates 42-5 to 42-16 are each formed at a position farthest from the center of the optical element array 42 within a range in which the light transmission parts 51-5 to 51-16 can be formed in the optical element plates 42-5 to 42-16, or formed at least at a position farther than the center of the optical element plates 42-1 to 42-4 with respect to the center of the optical element array 42. Furthermore, in a case where the imaging element array 61 is arranged vertically and horizontally symmetrically, the light transmission parts 51-1 to 51-16 are also arranged vertically and horizontally symmetrically, or the light transmission parts 51-1 to 51-4 are formed at positions where the common angle of view range or the continuous angle of view range is present in the angle of view range of vertically or horizontally adjacent imaging elements among each of the imaging elements 31-1 to 31-16.

According to the arrangement of the light transmission parts 51-1 to 51-16 of the optical element plates 42-1 to 42-16 in the second embodiment, the range of the subject to be imaged (angle of view range) is further enlarged as compared with the case of the first embodiment. Furthermore, in the image combining processing, regardless of the distance of the subject, because the cut-out range for cutting out the image to be joined can be identified to generate the wide-angle image with respect to the captured images captured by each of the imaging elements, the image combining processing is simplified.

The form of the transparent zones of the light transmission parts 51-5 to 51-16 is also determined according to the similar conditions as those of the transparent zones of the light transmission parts 51-1 to 51-4. That is, after the principal point positions of the light transmission parts 51-1 to 51-4 are determined in the optical element plates 42-5 to 42-16, the position of the XYZ coordinates (f·tan β,0,−f) assumed as the position where the light image with the maximum resolution is formed is determined to be the center position of the light receiving surface of each of the imaging elements 31-1 to 31-16 facing each of the optical element plates 42-1 to 42-16, or at least a position closer to the center of the light receiving surface than the position on the light receiving surface facing the principal point position. With this configuration, in each of the optical element plates 42-1 to 42-16, the direction of the XYZ axes of the XYZ coordinates with the principal point position as the origin and the constant used in the above Formula (1) such as the incident angle β of light forming the light image with the maximum resolution are determined. As a result, a region where the transparent zone is formed in each of the optical element plates 42-1 to 42-16 is determined by the above Formula (1). Also in the second embodiment, the form of the transparent zone of the light transmission parts 51-5 to 51-16 may be a form in which a pinhole, a zone plate, or a photon sieve is modified similarly to the first embodiment.

According to the form of the transparent zone of the light transmission parts 51-1 to 51-16 in the second embodiment, similarly to the first embodiment, even in a case where the light image formed obliquely with respect to the plate surface from the principal point position of the light transmission part 52 is the center of the light receiving surface of the imaging element as illustrated in FIGS. 12 and 13, the light image in the vicinity of the center of the light receiving surface or at an optional position can be made to have high resolution. In a case where a plurality of captured images is combined by image combining processing, the resolution can be made uniform over the entire combined image.

### <<Application Example of Present Technology>>

### <Application to Smartphone>

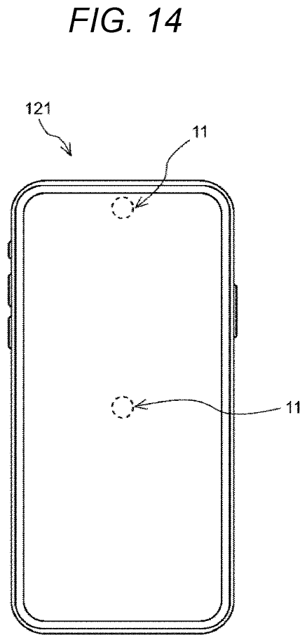

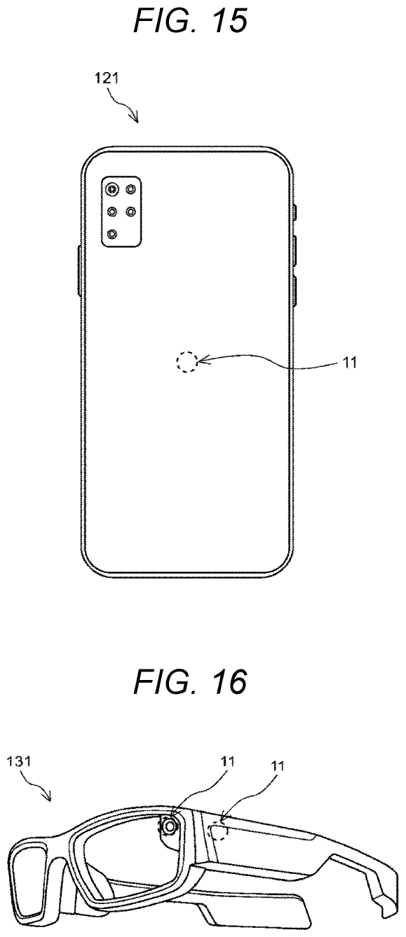

FIGS. 14 and 15 are views exemplifying a case where the present technology is applied to a smartphone. As illustrated in FIG. 14, on the display surface side of a smartphone 121, the imaging unit 11 in FIG. 1 is disposed as a fingerprint sensor immediately below an organic light-emitting diode (OLED). The position where the imaging unit 11 is disposed may be an optional position such as a central part or an upper end part of the display surface. By disposing the imaging unit 11 immediately below the OLED, the entire surface can be formed as the OLED while having the fingerprint sensor disposed at the end as in the current Front Camera. Furthermore, because the image forming optical element such as a pinhole has a deep depth of field, not only fingerprint imaging by close-up shooting can be performed but also a distant subject can be imaged. Therefore, the imaging unit 11 can also be used for face authentication, gesture control, and the like. In a case where the fingerprint sensor is disposed at the center of the OLED, not only it is easy to place a finger for fingerprint authentication, but it also becomes easy to take a line-of-sight at the time of selfie.

As illustrated in FIG. 15, the imaging unit 11 in FIG. 1 is disposed immediately below a surface coated with glass or a surface of another material such as metal on a surface on the opposite side to the display surface of the smartphone 121. With this arrangement, the imaging unit 11 can be disposed as a fingerprint sensor using the close-up shooting without impairing the design of the surface. Because a mark on which the finger to be placed is eliminated, unevenness or the like may be provided to guide the finger position.

### <Application to Smart Glasses>

FIG. 16 is a view exemplifying a case where the present technology is applied to smart glasses. As illustrated in FIG. 16, the imaging unit 11 in FIG. 1 is disposed on the side or under the front glass of smart glasses 131. With this arrangement, because the image forming optical element is the lensless image forming optical element, the imaging unit 11 can be disposed as a fingerprint sensor without impairing a design or the like. In addition to the fingerprint imaging by close-up shooting, the imaging unit 11 can also be used as a sensor for peripheral environment recognition and a non-contact gesture control sensor.

### <Application to Door in Entrance or the Like>

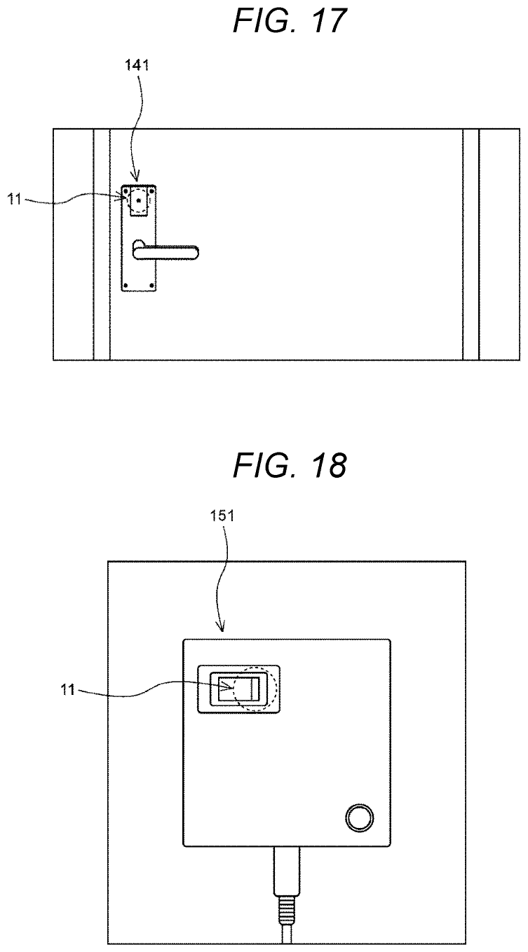

FIG. 17 is a view exemplifying a case where the present technology is applied to a door in an entrance or the like. As illustrated in FIG. 17, the imaging unit 11 in FIG. 1 is disposed in a part of a place covered entirely with a door 141 in an entrance or the like. With this arrangement, the imaging unit 11 can be used as a fingerprint authentication device for unlocking a door. By making the door automatically operated, the need for a doorknob can eliminated, and a door whose entire surface includes a uniform material can be constructed.

### <Application to Abnormality Watching Sensor>

FIG. 18 is a view exemplifying a case where the present technology is applied to an abnormality watching sensor. As illustrated in FIG. 18, the imaging unit 11 in FIG. 1 is disposed in an abnormality watching sensor 151. With this configuration, the imaging unit 11 can monitor a wider angle of view range by a thin sensor.

### <Application to Tactile Sensor>

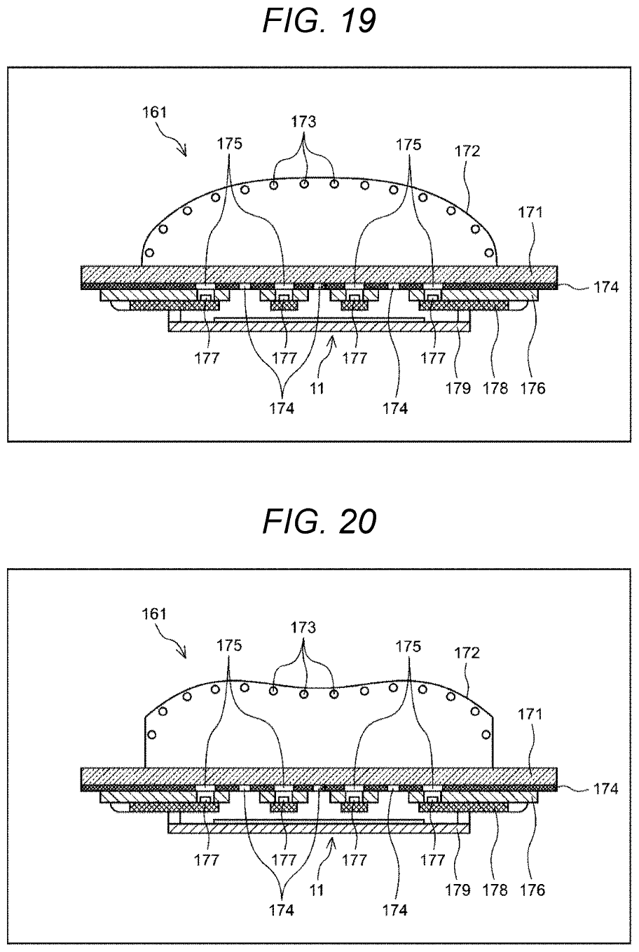

FIGS. 19 and 20 are views each exemplifying a case where the present technology is applied to a tactile sensor. A tactile sensor 161 in FIG. 19 has a plate-like glass 171, and a rubber 172 filled with gel is provided on the upper surface of the glass 171. A plurality of markers 173 is provided on the inner surface of the rubber 172. An optical element array 174 corresponding to the optical element array 42 illustrated in FIGS. 2, 12, and the like is provided on the lower surface side of the glass 171. The optical element array 174 is formed with a plurality of light transmission parts 174A corresponding to the plurality of light transmission parts 51 having transparent zones such as pinholes formed in the optical element array 42 in FIGS. 2 and 12. Furthermore, a plurality of light projecting holes 175 for light projection is formed in the optical element array 174. A light shielding plate 176 is provided on the lower surface side of the optical element array 174. A plurality of light emitting diodes (LEDs) 177 supported on a substrate 178 is provided corresponding to the positions of the light projecting holes 175 of the optical element array 174. The light emitted from the LED 177 passes through the light projecting hole 175 of the optical element array 174 and illuminates the markers 173 on the inner surface of the rubber 172. The light shielding plate 176 shields the periphery of the LED 177 so that the light emitted from the LED 177 does not leak in a direction other than the light projecting hole 175. An imaging element array 179 corresponding to the imaging element array 61 illustrated in FIGS. 2, 13, and the like is disposed on the lower surface side of the substrate 178 of the LED 177. The imaging element array 179 includes imaging elements (sections of the light receiving surface) respectively corresponding to the plurality of light transmission parts 174A of the optical element array 174. With this arrangement, the light from the LED 177 reflected by the markers 173 on the inner surface of the rubber 172 is incident on the plurality of light transmission parts 174A of the optical element array 174. Each of the light transmission parts 174A forms a light image of the markers 173 within each angle of view range on a section of a corresponding light receiving surface of the imaging element array 179 by light from the markers 173 in the angle of view ranges in different directions. Note that α member corresponding to the light shielding wall 43 illustrated in FIGS. 2, 12, and the like may be provided in the tactile sensor 161, or the light shielding plate 176 and the substrate 178 may have an action corresponding to that of the light shielding wall 43. Because the present technology is applied to the optical element array 174, the light image of the markers 173 having a wide angle of view range is captured by the imaging element array 179. In a case where an object comes into contact with the rubber 172, the rubber 172 is deformed as shown in FIG. 20, and the positions of the markers 173 are changed. A processing unit (not illustrated) of the tactile sensor 161 can measure the force applied to the rubber 172 by detecting a change (a change amount or the like) in the positions of the markers 173 from the captured image obtained from the imaging element array 179. According to such a tactile sensor 161, an image of the markers 173 having a wide angle of view range can be captured without a lens, and the tactile sensor can be manufactured at low cost.

### <Combination Examples of Configurations>

Note that the present technology can also have the following configurations.

(1)

An optical element including an optical element plate that includes, in part, a light transmission part forming a light image of an object by light from the object, the light having passed through a transparent zone that transmits light, and that blocks light in a portion other than the transparent zone, in which the transparent zone is formed such that resolution of a light image formed in a direction different from a normal direction of a plate surface of the optical element plate with respect to the light transmission part is higher than resolution of a light image formed in the normal direction.

(2)

The optical element according to (1), in which
the transparent zone is an opening formed in the optical element plate.
   (3)

The optical element according to (1) or (2), in which
the transparent zone is formed in a form corresponding to a pinhole, a zone plate, or a photon sieve.
   (4)

The optical element according to any one of (1) to (3), in which
the optical element plate has a principal point position at which light from an object point incident on the light transmission part travels straight to an image point, and the transparent zone has an elongated shape in one direction and a shape extended in an opposite direction to one direction with respect to the principal point position.
   (5)

The optical element according to (4), in which
the one direction and the opposite direction are directions along a direction of a position where a light image having a maximum resolution is formed with respect to the principal point position.
   (6)

The optical element according to any one of (1) to (5), further including
an optical element array in which a plurality of the optical element plates is aligned.
   (7)

The optical element according to (6), in which
the optical element array includes a light shielding wall that defines a region of a light image formed by each of the plurality of the optical element plates.
   (8)

The optical element according to (6) or (7), in which
the light transmission part of each of the plurality of the optical element plates is provided at a position farther than a center position of each of the plurality of the optical element plates with respect to a center position of the optical element array.
   (9)

The optical element according to any one of (6) to (8), in which
the light transmission parts of the plurality of the optical element plates form light images respectively having angle of view ranges in different directions.
   (10)

The optical element according to (9), in which,
among the plurality of the optical element plates, the light transmission parts of the optical element plates adjacent to each other include a common angle of view range among the angle of view ranges of the optical element plates adjacent to each other.
   (11)

The optical element according to any one of (1) to (10), in which
the optical element plate is disposed at a position facing a light receiving surface of an imaging element.
   (12)

An optical device including:
an imaging element; and an optical element disposed at a position facing a light receiving surface of the imaging element, in which
the optical element includes an optical element plate that includes, in part, a light transmission part forming a light image of an object by light from the object, the light having passed through a transparent zone that transmits light, and that blocks light in a portion other than the transparent zone, in which the transparent zone is formed such that resolution of a light image formed in a direction different from a normal direction of a plate surface of the optical element plate with respect to the light transmission part is higher than resolution of a light image formed in the normal direction.
   (13)

The optical device according to (12), in which
the optical element plate has a principal point position at which light from an object point incident on the light transmission part travels straight to an image point, and the transparent zone has an elongated shape in one direction and a shape extended in an opposite direction to one direction with respect to the principal point position.
   (14)

The optical device according to (13), in which
the one direction and the opposite direction are directions along a direction of a position where a light image having a maximum resolution is formed with respect to the principal point position.
   (15)

The optical device according to any one of (12) to (14), further including
an optical element array in which a plurality of the optical element plates is aligned.
   (16)

The optical device according to (15), in which
the optical element array includes a light shielding wall that defines a region of a light image formed by each of the plurality of the optical element plates.
   (17)

The optical device according to (15) or (16), in which
the light transmission part of each of the plurality of the optical element plates is provided at a position farther than a center position of each of the plurality of the optical element plates with respect to a center position of the optical element array.
   (18)

The optical device according to any one of (15) to (17), in which
the light transmission parts of the plurality of the optical element plates form light images respectively having angle of view ranges in different directions.
   (19)

The optical device according to (18), in which,
among the plurality of the optical element plates, the light transmission parts of the optical element plates adjacent to each other include a common angle of view range among the angle of view ranges of the optical element plates adjacent to each other.
   (20)

The optical device according to any one of (15) to (19), further including
an imaging element array in which a plurality of the imaging elements corresponding to each of the plurality of the optical element plates of the optical element array is aligned, in which
the plurality of the imaging elements respectively corresponding to the plurality of the optical element plates captures a light image formed by the light transmission parts of the plurality of the optical element plates.

Note that, the present embodiment is not limited to the embodiment described above, and various modifications can be made without departing from the gist of the present disclosure. Furthermore, the effects described in the present description are merely examples and are not limited, and other effects may be provided.

### REFERENCE SIGNS LIST

1 Optical device
11 Imaging unit
12 Image processing unit
31-1 to 31-16 Imaging element
41 Optical element
42 Optical element array
42-1 to 42-16 Optical element plate
43 Light shielding wall
51-1 to 51-16 Light transmission part
61 Imaging element array

1. An optical element comprising an optical element plate that includes, in part, a light transmission part forming a light image of an object by light from the object, the light having passed through a transparent zone that transmits light, and that blocks light in a portion other than the transparent zone, wherein the transparent zone is formed such that resolution of a light image formed in a direction different from a normal direction of a plate surface of the optical element plate with respect to the light transmission part is higher than resolution of a light image formed in the normal direction.

2. The optical element according to claim 1, wherein
the transparent zone is an opening formed in the optical element plate.

3. The optical element according to claim 1, wherein
the transparent zone is formed in a form corresponding to a pinhole, a zone plate, or a photon sieve.

4. The optical element according to claim 1, wherein
the optical element plate has a principal point position at which light from an object point incident on the light transmission part travels straight to an image point, and the transparent zone has an elongated shape in one direction and a shape extended in an opposite direction to one direction with respect to the principal point position.

5. The optical element according to claim 4, wherein
the one direction and the opposite direction are directions along a direction of a position where a light image having a maximum resolution is formed with respect to the principal point position.

6. The optical element according to claim 1, further comprising
an optical element array in which a plurality of the optical element plates is aligned.

7. The optical element according to claim 6, wherein
the optical element array includes a light shielding wall that defines a region of a light image formed by each of the plurality of the optical element plates.

8. The optical element according to claim 6, wherein
the light transmission part of each of the plurality of the optical element plates is provided at a position farther than a center position of each of the plurality of the optical element plates with respect to a center position of the optical element array.

9. The optical element according to claim 6, wherein
the light transmission parts of the plurality of the optical element plates form light images respectively having angle of view ranges in different directions.

10. The optical element according to claim 9, wherein,
among the plurality of the optical element plates, the light transmission parts of the optical element plates adjacent to each other include a common angle of view range among the angle of view ranges of the optical element plates adjacent to each other.

11. The optical element according to claim 1, wherein
the optical element plate is disposed at a position facing a light receiving surface of an imaging element.

12. An optical device comprising:
an imaging element; and an optical element disposed at a position facing a light receiving surface of the imaging element, wherein
the optical element includes an optical element plate that includes, in part, a light transmission part forming a light image of an object by light from the object, the light having passed through a transparent zone that transmits light, and that blocks light in a portion other than the transparent zone, in which the transparent zone is formed such that resolution of a light image formed in a direction different from a normal direction of a plate surface of the optical element plate with respect to the light transmission part is higher than resolution of a light image formed in the normal direction.

13. The optical device according to claim 12, wherein
the optical element plate has a principal point position at which light from an object point incident on the light transmission part travels straight to an image point, and the transparent zone has an elongated shape in one direction and a shape extended in an opposite direction to one direction with respect to the principal point position.

14. The optical device according to claim 13, wherein
the one direction and the opposite direction are directions along a direction of a position where a light image having a maximum resolution is formed with respect to the principal point position.

15. The optical device according to claim 12, further comprising
an optical element array in which a plurality of the optical element plates is aligned.

16. The optical device according to claim 15, wherein
the optical element array includes a light shielding wall that defines a region of a light image formed by each of the plurality of the optical element plates.

17. The optical device according to claim 15, wherein
the light transmission part of each of the plurality of the optical element plates is provided at a position farther than a center position of each of the plurality of the optical element plates with respect to a center position of the optical element array.

18. The optical device according to claim 15, wherein
the light transmission parts of the plurality of the optical element plates form light images respectively having angle of view ranges in different directions.

19. The optical device according to claim 18, wherein,
among the plurality of the optical element plates, the light transmission parts of the optical element plates adjacent to each other include a common angle of view range among the angle of view ranges of the optical element plates adjacent to each other.

20. The optical device according to claim 15, further comprising
an imaging element array in which a plurality of the imaging elements corresponding to each of the plurality of the optical element plates of the optical element array is aligned, wherein
the plurality of the imaging elements respectively corresponding to the plurality of the optical element plates captures a light image formed by the light transmission parts of the plurality of the optical element plates.
